(19) United States
(12) Patent Application Publication
(10) Pub. No.: US 2009/0133493 A1
(43) Pub. Date: May 28, 2009

(54) Measuring scoop for prep cooking

(75) Inventor: Dwight David Roberts, Scottsdale, AZ (US)

Correspondence Address: HESLIN ROTHENBERG FARLEY & MESITI PC, 5 COLUMBIA CIRCLE, ALBANY, NY, 12203, US

(73) Assignee: Chef's Planet, LLC

(21) Appl. No.: 11/998,287

(22) Filed: Nov. 28, 2007

(51) Int. Cl. G01F 19/00

(52) U.S. Cl. 73/426

(57) ABSTRACT

There is provided a unitary measuring scoop for scooping and measuring chopped food material that includes a scoop shell and a measuring insert. The scoop shell includes a back with a leading edge, a first side with a first wing, a second side with a second wing, and a bottom, and together these elements define a holding area where food can be scooped. The measuring insert includes a lower measuring insert and an upper measuring insert which may be of a clear plastic material. Measuring indicia are imprinted on the measuring inserts so that a user can view a level of food in the measuring inserts and judge its quantity against the indicia. Food scooped onto the holding area of the scoop shell is easily drawn into the measuring insert. The scoop shell and measuring insert are shaped such that the measuring insert readily fits into the holding area of the scoop shell, and the measuring insert can be affixed to the scoop shell. The lower measuring insert can be sized so that it holds approximately one cup of food material, and the upper measuring insert can be sized so as to hold approximately an additional cup of food material. In this way the user can select an amount of food material to be collected.

### FIELD OF THE INVENTION

The present invention relates to cooking implements. More particularly the present invention relates to a combined measuring and food handling utensil adapted for use with preparatory food work in cooking.

### BACKGROUND OF THE INVENTION

The culinary arts are widely popular, and a variety of utensils and implements have been developed to assist chefs and cooks in various cooking steps and procedures. One aspect of cooking deals with “prep work”. Prep work or food preparation work generally relates to that segment of cooking in which the various components and ingredients in a recipe are gathered, perhaps cut or manipulated in some manner, sometimes measured, and then placed into some common cooking means. For example, if a potato salad recipe calls for one cup of chopped eggs. The chef performs “prep work” by peeling hard boiled eggs, placing them on a cutting board, chopping the eggs, scooping the chopped egg into a measuring cup, and then transferring them into a mixing bowl. Similarly, a meat loaf recipe might call for a cup of chopped onions and a half cup of chopped green peppers. The prep work involves taking the onion and pepper, chopping a desired amount of the food on the cutting board, measuring the chopped materials, and then transferring the chopped onion and green pepper to a cooking dish. Another example relates to the preparation of stuffings in Thanksgiving recipes; such recipes call for a variety of sometimes loose food materials such as chopped nuts, chopped fruits, bread crumbs, and seasonings. All these loose materials are cut, gathered, measured, and then combined. A final example is grating a desired amount of cheese for a recipe. There are numerous examples relating to food prep work.

Handling of food materials during prep work represents two different kinds of problems. The first problem relates to the physical handling of loose, flowing materials. The second difficulty in dealing with food materials during food prep work is how to accurately and efficiently measure their quantity. Each of these problems, and their ongoing existence even with prior art instruments, is further elaborated below. It is noted, however, that much of the difficulty in physical handling of food materials is related in U.S. Pat. No. 6,733,056, entitled SCOOP UTENSIL, now owned by the assignee of the present application. However, even this prior art does not address how to combine both aspects of food handling and measuring during prep work.

With respect to the first issue, the physical handling of chopped and diced materials, food preparation and cooking generally requires transport of food objects from an area where the food objects are manipulated and processed to the cooking utensil in which the food is prepared. An example of this is moving diced-up meat from a cutting board to a pan where the meat will cook. It is desirable to transport the food objects in a quick and convenient manner without spilling and therefore wasting food objects. It is also desirable to move the food objects with limited contact between the food objects and the person. This prevents undesirable transfer of bacteria and other forms of unwanted contamination from the food objects to the person and vice a versa.

Chefs have long used knives, graters, choppers and other cutting utensils in the kitchen for chopping, dicing, shredding, and grating foods for cooking. For example, vegetables such as onions, radishes, celery, lettuce, and the like often are chopped, diced, or shredded into small pieces for use in soups and salads. Graters often are used to create mounds of grated cheeses for pizzas, salads, and soups. Traditionally, when a mound of chopped or grated food is to be picked up and placed into a dish being prepared by a chef, the chef simply scoops up the mound between cupped hands, carries it to the dish under preparation, and dumps it in the dish. While this technique certainly is functional and has been used successfully for centuries, it nevertheless has various inherent shortcomings that render it less than optimum. For instance, in order that the hands can be used to scoop up food, all other utensils must be put down. In addition, the act of scooping up the food and carrying it across the kitchen to be placed in a pan, pot, or dish requires the full use of both hands, which therefore are not available for other activities. The very shape of the hands themselves renders them inefficient for scooping and, invariably, some of the chopped-up food being scooped is left behind to be scraped into a sink or otherwise discarded. Such clean up is a wasteful and time consuming task. The chef also must stop to wipe or clean his or her hands after having scooped up and dumped the chopped food, which takes even more time. Finally, the use of the hands in this way can be unsanitary if, for example, the hands are not properly cleaned or carry undesirable bacteria or other contaminates from other food, such as uncooked poultry, that has been handled by the chef.

Some chefs have been known to improvise in an attempt to improve upon the hand-scooping of chopped-up foods by using a cookie sheet, cutting board, dough cutter, or other flat utensil for scooping up food instead of scooping it up with the hands. While this can help, it nevertheless is an unsatisfactory solution because these utensils are not properly sized or shaped for the job, are awkward to handle in such a task, and/or tend to spill the chopped-up food over the sides of the utensil.

Accordingly, a persistent need exists for a utensil that can be used in the kitchen for scooping up mounds of chopped, shredded, and grated foods quickly and efficiently, carrying the food across the kitchen, and dumping it into a soup or other dish being prepared. Such a utensil should be simple and easy to manipulate by a chef without requiring the use of both hands. Further, it should be sanitary, should prevent the scooped-up food from being spilled while being moved, and should be attractive, compact, and economical to manufacture. It is to the provision of such a utensil that the present invention is primarily directed.

In addition to this issue of physically handling inherently loose and sometimes flowing food materials, there is the added problem of how to properly and efficiently measure their quantity. A recipe will typically call for a set amount of food material such as a cup of chopped onions, half cup of grated cheese, etc. The food handling utensils for use during food prep as described above do not have a means in which to measure the food. For example, a knife edge or scraper has no indicia of quantity.

Heretofore, different tools have dealt with the different food handling functions. Items such as scoops and measuring tools each are devoted to the separate issues of food handling and food measuring. Thus, a well stocked kitchen includes multiple food handling and food measuring items. There is an ongoing need for simplification. It would be desired to provide a single, unified implement for food prep work that both collects chopped food materials and measures those materials.

In this situation, the chef may often estimate or approximate a quantity of chopped food materials. An experienced chef can perhaps make a good estimate of food quantity based on visual inspection. While this may be satisfactory for the experienced or professional chef, it is not an acceptable means of measuring food quantity for the less-experienced cook. The amateur chef often has to make a difficult transfer of chopped food materials into a device such as a measuring cup. For all the reasons explained above, this is a difficult and time consuming step necessitated by the inability to easily measure chopped foods. It would be desired to provide a method and means to increase the efficiency of measuring chopped food items.

Hence there has been identified a need to provide an improved food scooping and measuring implement. It would be desired that a single kitchen implement provide an efficient means for gathering and collecting chopped food material such that the food materials can be easily transferred to a further cooking process. It would also be desired that the same kitchen implement also provide a means for measuring the chopped food materials. Further, it would be desired that a single, unified kitchen implement be robust, easy to use, made of food safe and dishwasher safe materials, and be relatively inexpensive. The present invention addresses one or more of these needs.

### SUMMARY OF THE INVENTION

In accordance with a first aspect of the present invention, and by way of example only, there is provided a unitary measuring scoop for scooping and measuring chopped food material that includes a scoop shell and a measuring insert. The scoop shell includes a back with a leading edge, a first side with a first wing, a second side with a second wing, and a bottom, and together these elements define a holding area where food can be scooped. The measuring insert includes a lower measuring insert and an upper measuring insert which may be of a generally clear material such as plastic or glass (including borosilicates). Measuring indicia are imprinted on the measuring inserts so that a user can view a level of food in the measuring inserts and judge its quantity against the indicia. Food scooped onto the holding area of the scoop shell is easily drawn into the measuring insert. The scoop shell and measuring insert are shaped such that the measuring insert readily fits into the holding area of the scoop shell, and the measuring insert can be affixed to the scoop shell. The lower measuring insert can be sized so that it holds approximately one cup of food material, and the upper measuring insert can be sized so as to hold approximately an additional cup of food material. In this way the user can select an amount of food material to be collected.

In another aspect of the present invention, still by way of example only, there is provided a measuring scoop for use in handling and measuring food materials. The utensil or measuring scoop includes a scoop shell and a measuring insert positioned in the scoop shell. The measuring insert can be a single piece, and in another embodiment the measuring insert comprises a lower measuring insert and an upper measuring insert. The lower measuring insert and the upper measuring insert further include a means for reciprocally connecting such as by way of lap joint, butt joint, scarf joint or the like. Additionally both the scoop shell and the measuring insert comprise means for reciprocally attaching to each other such as a flange/recess, ridge/recess, dent/detent, or the like, and in this manner the measuring insert can be held in a desired position with respect to scoop shell so that food can be scooped and then settled into the measuring insert. The measuring insert includes measuring indicia, such as 1 cup, 2 cups, etc. such that a user can determine the amount of food material held in the measuring insert by viewing the surface of the food material against the indicia. The measuring insert may be a clear material, such that a user can view the food material through the clear material; or alternatively the measuring insert may be opaque. Other structures may be included on the scoop shell to aid in handling such as a grip, a bottom support for allowing the measuring scoop to stand in a generally vertical position, and a push surface. The bottom support may include knobs, bumps, or legs. Additionally a rubber grip surface may cover all or a portion of the bottom of the scoop shell.

In still a further aspect of the present invention, and still by way of example only, there is provided a method for scooping and measuring food material with a single food implement. The method includes the steps of: sliding a measuring scoop having a front edge along a surface where the food material is disposed so as to scoop food material onto the measuring scoop; raising the measuring scoop from the surface to a substantially so as to allow the food material to settle into a substantially clear measuring insert with measuring indicia positioned on the measuring insert; and viewing the level of the food material against the measuring indicia so as to determine the quantity of food material. This method may also include the step of positioning a first measuring insert within a scoop shell so as to assemble the measuring scoop for measuring up to 1 cup of food material. It may also include the step of positioning g a second measuring insert within a scoop shell so as to assemble the measuring scoop for measuring up to 2 cups of food material.

Other independent features and advantages of the measuring scoop for prep cooking will become apparent from the following detailed description, taken in conjunction with the accompanying drawings which illustrate, by way of example, the principles of the invention.

### BRIEF DESCRIPTION OF THE DRAWINGS

FIG. 1 is a perspective view of a measuring scoop, according to an embodiment of the present invention;

FIG. 2 is a perspective view of a scoop shell of the measuring scoop, according to an embodiment of the present invention;

FIG. 3 is an exploded perspective view of a measuring insert of the measuring scoop, according to an embodiment of the present invention;

FIG. 4 is a close up view of the connection between a first measuring scoop and a second measuring scoop, according to an embodiment of the present invention;

FIG. 5 is a further perspective view of the measuring scoop, showing the bottom thereof, according to an embodiment of the present invention;

FIG. 6 is a further perspective view of the measuring scoop, according to an embodiment of the present invention;

FIG. 7 is a further perspective view of the measuring scoop, showing the back thereof, according to an embodiment of the present invention;

FIG. 8 is a flow chart showing steps in measuring food materials with the measuring scoop, according to an embodiment of the present invention;

FIG. 9 is a perspective view of the measuring scoop illustrating rubber legs, according to an embodiment of the present invention;

FIG. 10 is a perspective view of the measuring scoop illustrating a rubber grip bottom area, according to an embodiment of the present invention; and

FIG. 11 is a perspective view of a further measuring scoop having a fixed measuring face piece, according to a further embodiment of the present invention.

### LIST OF REFERENCE NUMERALS

Wherever possible, the same reference numbers will be used throughout the drawings to refer to the same or like parts.

10 measuring scoop

11 scoop shell

12 measuring insert

21 back

22 first side

23 first wing

24 second side

25 second wing

26 bottom

27 scoop edge

28 holding area

31 lower measuring insert

32 wall

33 bottom

34 top edge

35 upper measuring insert

36 bottom edge

37 lap joint

38 holding structure

39 measuring indicia

40 storage area

51 grip

55 push surface

56 bottom support

57 legs

58 rubber bottom area

61 front

62 back

63 sides

80 prepare chopped food material

81 assemble measuring scoop

82 slide measuring scoop to gather portion of chopped food material

83 raise measuring scoop

84 measure quantity of food material

85 repeat steps 82-84 until desired quantity is collected

86 dump contents

87 transfer contents to desired cooking location

90 face piece

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings.

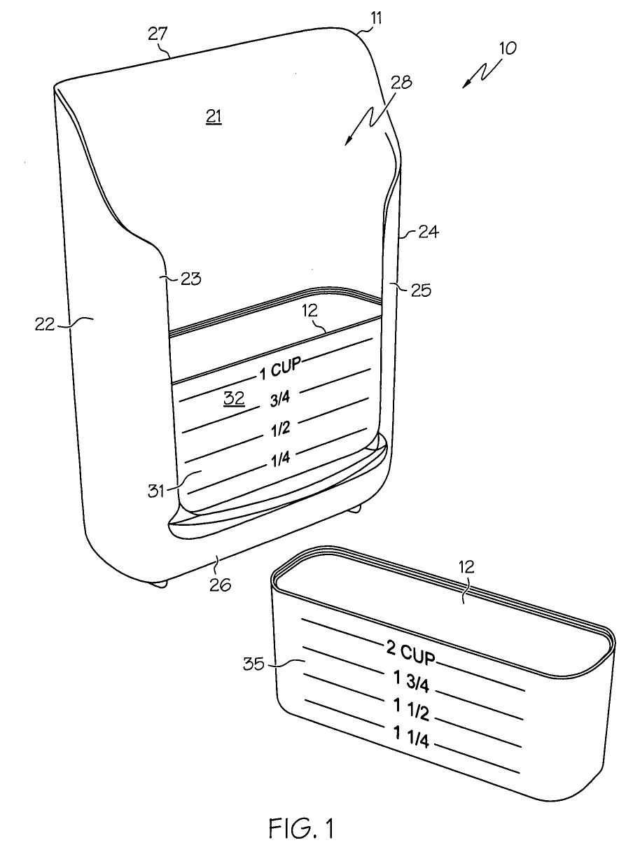

Referring initially to FIGS. 1 and 6 there is shown a preferred embodiment of measuring scoop 10. Measuring scoop 10 includes scoop shell 11 and measuring insert 12. Preferably, measuring insert 12 can be inserted into and removed from scoop shell 12. And further, it is also preferred that measuring insert 12 itself breaks down into two single cup measuring pieces. As explained further herein, scoop shell 11 and measuring insert 12 are configured so that measuring insert 12 can be positioned with respect to scoop shell 11 in a position such that food scooped into measuring insert 12 can be easily measured by a user/chef. Thus, measuring scoop 10 provides both a food handling and a food measuring function in a single device.

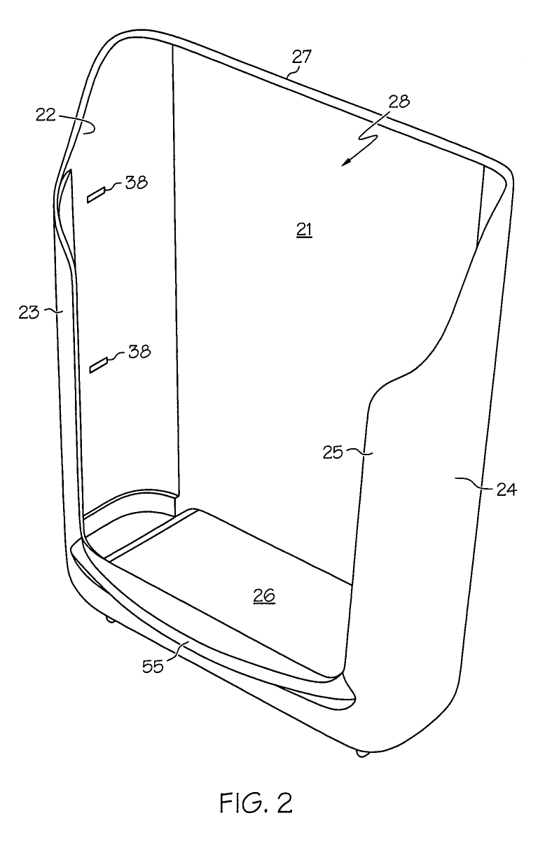

Referring now to FIG. 2 an embodiment of scoop shell 11 is shown. In a preferred embodiment, scoop shell 11 comprises a unitary structure that includes back 21, first side 22, second side 24, and bottom 26. Further, first side 22 also extends to form a first wing structure 23, and second side extends to form a second wing structure 25. As described further herein, first wing 23 and second wing 25 are useful for holding measuring insert 12 in a desired location relative to scoop shell 11. Together, back 21, bottom 26, first side 22, and second side 24 define holding area 28; and holding area 28 is the general location where measuring insert 12 is positioned when assembled with scoop shell 11. Back 21 terminates at its open edge with scoop edge 27. Scoop edge 27 can be somewhat beveled or angled so that food materials can easily slide across that edge.

It is to be appreciated that FIG. 2 illustrates a generally preferred embodiment of scoop shell 11 though variations from this embodiment are possible. For example, structures such as back 21, first side 22, second side 24, and bottom 26 are illustrated as generally flat, planar surfaces in a significant part of their surface. However, these surfaces can be curved and need not be flat. FIG. 2 also illustrates a preferred embodiment in which these structures, as well as first wing 23 and second wing 25, are joined to one another in generally curved corners. Such curved corners provide strength and are aesthetically pleasing; however other kinds of corners, such as sharp or angled corners are possible. A further feature of the preferred embodiment of scoop shell 11 is the manner in which first side 22 and first wing 23 terminate with respect to scoop edge 27 of back 21, and also how second side 24 and second wing 25 also terminate. The preferred embodiment is an ogee-type curve (connected concave and convex arcs), though other shapes of curves and lines are possible.

The scoop shell 11 may be used as a stand alone item. For example, a user can employ scoop shell 11 to gather, scoop, and collect chopped food materials. U.S. Pat. No. 6,733,056, entitled SCOOP UTENSIL, now owned by the assignee of the present patent application, describes methods for using a food scoop during food prep work; and this patent is incorporated herein by reference. In one manner of usage, a cook or user positions scoop shell 11 against a cutting surface such as a cutting board such that scoop edge 27 makes substantial contact with this surface. Back 21 may be set at an angle with respect to the work surface. Then, by sliding scoop shell 11 along the surface, food materials will cross over scoop edge 27 and only back 21 of scoop shell 11.

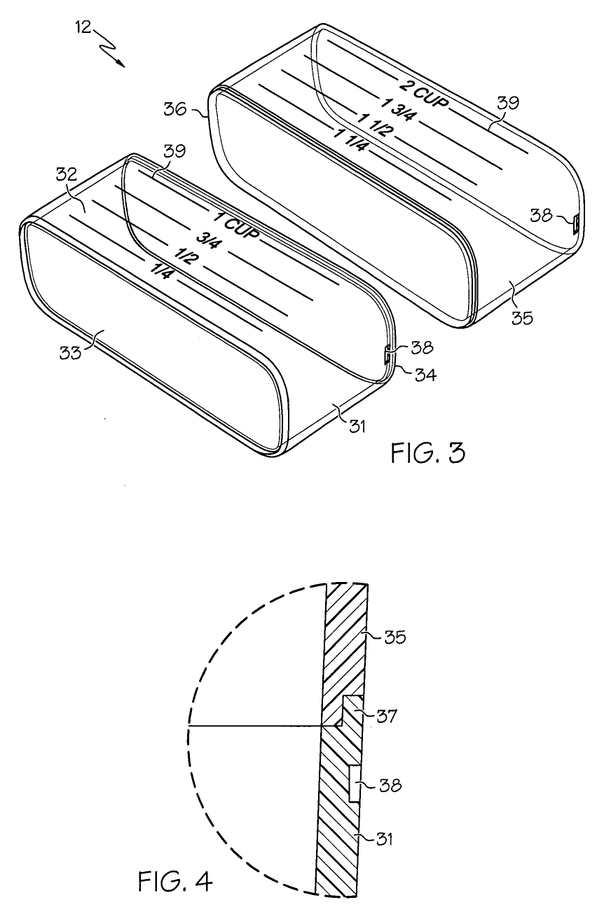

Referring next to FIGS. 3 and 4 there is shown a preferred embodiment of measuring insert 12. According to this embodiment, measuring insert 12 includes two sections, a lower measuring insert 31 and an upper measuring insert 35. (Of course other numbers of inserts are possible.) In addition, the lower measuring insert 31 and upper measuring insert 35 each generally define a volume of approximately 1 cup, so that in combination a total of approximately 2 cups can be measured.

Still referring to these figures, lower measuring insert 31 defines a generally cup-like or bowl-shaped container in that lower measuring insert 31 can hold solids, fluids, or blends of solids and fluids, with substantially little or no leaking. In the illustrated preferred embodiment, lower measuring insert 31 includes a bottom 33, which is attached to a set of walls 32, such as a front 62, back 62, and two sides 63. The walls may be positioned generally vertically with respect to bottom 33, though other configurations are possible. Preferably the top area of lower insert 31 is open such that food materials can pass through the top into the internal storage area 41 of lower insert 31. As shown the front and back portions can merge with each of the side portions in a generally curved corner, though sharp corners are certainly acceptable. In addition the corner between walls and bottom 33 can be curved or angled. Whatever external shape given to lower measuring insert 31, it is generally preferred, as described herein, that insert 31 can be positioned in a holding area 28 defined by shell 11 and loosely affixed therein.

FIG. 3 also illustrates upper measuring insert 35. In the preferred embodiment, upper measuring insert 35 shares a similar gross external shape with lower measuring insert 31, except for the fact that upper measuring insert 35 is open at both a top position and bottom position. Unlike lower measuring insert 31, upper measuring insert 35 preferably has no significant bottom. As with lower measuring insert 31, upper measuring insert 35 may include wall structures including a front 61, back 62, and two sides 63, which are joined whether by curved or angled junctures.

Referring next to FIG. 4, there is shown a close up view of a preferred junction between lower measuring insert 31 and upper measuring insert 35. FIG. 4 illustrates a lap joint 37 as this form of joinder. In order to form the lap joint, top edge 34 of lower insert 31 and bottom edge 36 of upper insert 35 each define a reciprocally matching half lap surface such that when bottom edge 36 comes into proximity with top edge 34, these two surfaces can join to form a full lap joint 37. Other forms of joinery are possible, such as, by way of example only, dado, tongue-and-groove, butt-joint, rabbet, scarf, and splice joints.

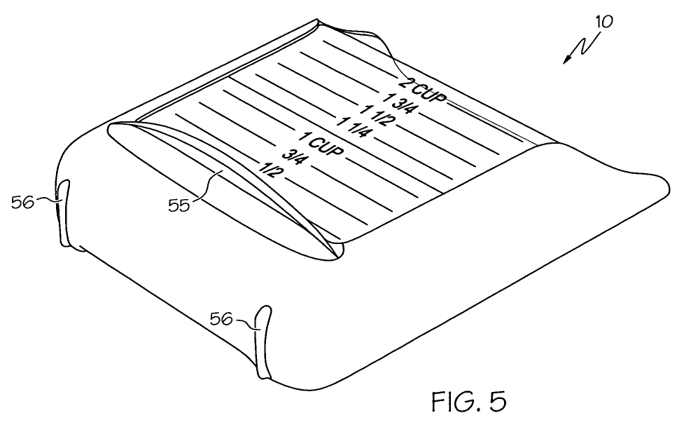

As previously mentioned, measuring scoop 10 is preferably arranged such that a one or two piece measuring insert 12 joins with scoop shell 11 to form the completed measuring scoop 10. Referring now to FIGS. 5 and 6, there is shown an embodiment of measuring scoop 10 in which both a lower measuring insert 31 and an upper measuring insert 35 have been assembled with scoop shell 11. FIG. 1 shows that embodiment in which only the lower measuring insert 31 has been assembled with scoop shell 11. It will thus be appreciated that the gross exterior shape of inserts 31 and 32 is such that a close fit is achieved when these inserts are assembled with shell 11. Side walls 63 of upper and lower inserts 31 and 35 preferably come into close proximity with an interior surface of first side 22 and second side 24 of shell 11. Additionally back 62 of inserts 31 and 32 also comes into close proximity with bottom 26 of scoop 11. Again, bottom 33 of lower insert 31 comes into close proximity with bottom 26 of scoop shell 11. Finally, it is also noted that first wing 23 and second wing 25 also assist in holding inserts 31 and 35 in the assembled position. Each of first wing 23 and second wing 25 are configured so as to fold over and partially contact front 61 of lower insert 31 and upper insert 35. In a preferred embodiment, each of wings 23 and 25 also extend toward scoop edge 27 sufficiently so as reach, or come into proximity with, the top edge 34 of upper insert 35. It is further noted that the corner curvatures in both scoop shell 11 and measuring insert 12 closely match such that measuring insert 12 can seat in close contact with shell 11.

As just described, both scoop shell 11 and measuring insert 12 are mutually shaped such that measuring insert 12 can easily slip into and out of an assembled position with scoop shell 11. However, it is also preferred to provide some means of holding measuring insert 12 in the assembled position; and further it is preferred to hold measuring insert 12 in the assembled position such that the measuring insert 12 would not fall out of scoop shell 11 if the measuring scoop 10 is inverted. Rather, it is preferred to provide a means of securing the measuring insert 12 such that some degree of modest manual effort by a user/chef is required to free measuring insert 12 from the assembled position. In one embodiment, mutually fitting holding structures 38 are provided on side walls of both the scoop 11 and the insert 12. The holding structures 38 may be any reciprocally engaging means such as a ridge and recess, a dent and detent receiver, or a male and female engagers. To take the example of a dent and receiver, an outwardly structured dent is positioned on both the first side 22 and second side 24 of the scoop 11. An inward recess or detent, structured so as to match with the dent, is positioned on both side walls 63 of lower measuring insert 31. Each of these structures is configured and positioned such that when insert 31 is assembled with scoop 11 and reaches its fully assembled, bottomed position the detent and recess align and engage with each other. A slight flexibility or give in the walls of the both the scoop 11 and insert 12 allow the dent to slide along until it locks with the detent/recess; and likewise that springiness in the walls is what snaps the detent/recess in place and holds them engaged. The dent/recess structures can be affixed so that either of the scoop 11 and insert 12 receive one or the other of the dent. And preferably, dent/recess structures are positioned on both a lower measuring insert 31 as well as an upper measuring insert 35. In this manner both lower measuring insert 31 and upper measuring insert 35 can be individually locked into position. A dent/recess structure are disengaged by slightly pulling apart the walls that have been engaged, as by slight manual pressure, so as to remove dent from its locked position in the recess. While this explanation has been provided with respect to the dent/recess example of holding structure 38, it will be understood that a similar explanation of other kinds of holding structures 38 also would apply. In an optional embodiment, both lower insert 31 and upper insert 35 can be flipped front-to-back without affecting their ability to lock and assemble into the measuring scoop 10.

It is noted that measuring insert 12 may be a one-piece unit, and that it may be shaped so as to measure some quantity of material even greater than 2 cups. For example in some applications, such as with commercial kitchens, it may be advantageous to have a one piece measuring insert 12 that measures up to 4, 6, or greater number of cups.

In a preferred embodiment, measuring indicia 39 are displayed on each measuring insert 31 and 35. Additionally, indicia 39 are preferably configured so as to be visible to a user when measuring insert 12 is fully assembled with scoop insert 11. Indicia 39 are markings (preferably both line markings and number markings) that indicate a volume or other measure of food material, such as, ¼ cup, ½ cup, ¾ cup, 1 cup, etc. In a preferred embodiment, first measuring insert 31 includes indicia 39 that show measurements up to 1 cup, and second measuring insert 35 includes indicia 39 that show measurements up to 2 cups. In this manner a user can use only the first measuring insert 35, without the need for the second measuring insert 35, if he or she knows that he needs only to measure up to 1 cup of material. And by deploying second measuring insert 35 together with first measuring insert 31, a user can measure up to two cups of food material. The measuring indicia are preferably drawn so as to indicate volumes of material when the measuring scoop 10 is in a substantially vertical position. Indicia 39 are preferably placed on at least a front wall 61 of inserts 31 and 35, and more preferably on both front 61 and back 62 of the inserts. Indicia 39 may be placed on inserts 31 and 35 by any known method such as painting, plastic molding, metal etching, etc.

Preferably measuring insert 12 and its components inserts 31 and 35 are formed of a clear (or substantially clear) plastic matrix with solid colored indicia 39. Glass materials may also be used. In this configuration a user would view the food materials within the interior of measuring insert 12 through the outer matrix. Additionally the top level of the food material would be visible and could be measured against an indicia line from the top opening of measuring insert 12.

While in one preferred embodiment the measuring insert 12 is generally clear, in other embodiments it can be a solid, non-transparent material. Thus, for example it could be made of a stainless steel or other kitchen-grade metal. Indicia lines 39 could be engraved in such an embodiment. A user could make measurements by viewing the food material in the holding area through the top of the measuring insert.

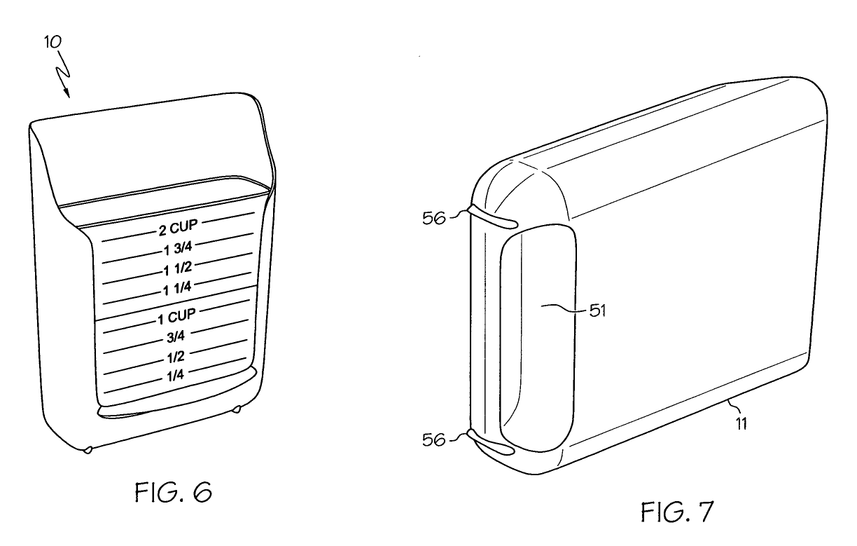

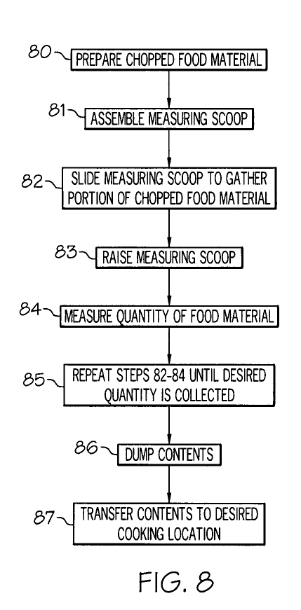

Various optional, though user-friendly, features can be incorporated into the measuring scoop 10, which while not essential are helpful in the purposes and uses of the invention. For example, referring to FIG. 7, a grip 51 can be incorporated into the base area of shell 11. Grip 51 generally comprises a combination of hollow space and pulling surfaces such that a human user can position various fingers or finger tips into the area proximate to grip 51. Thus, for example, when a user desires to set scoop edge 27 at an angle with respect to a working surface, grip 51 is easily accessed by the user's fingers. The user can thus exert force onto the grip 51 and thus manipulate measuring scoop 10. Grip 51 is also found to be useful when a user inserts or removes the measuring inserts 31 and 35 with respect to scoop shell 11. In the operation of removing inserts 31 and 35 from scoop shell 11, a user may find it helpful to hold and restrain scoop shell 11 from unnecessary movement. The user can thus grasp scoop shell 11 by placing his or her fingers in the area defined by grip 51 and by doing so stabilize scoop shell 11. With the other hand, the user can grasp a portion of either upper measuring insert 35 or lower measuring insert 31, and then by gently pulling in opposite directions, the user breaks either of the inserts free from their loose attachment to scoop shell 11.

Next, referring generally to FIGS. 1, 2, 5, 6, and 7, optional feature push surface 55 is illustrated. Push surface 55 comprises a generally raised surface or partial wall proximate bottom 26 of scoop shell 11. Push surface 55 can generally run from first side 22 to second side 24. The functional advantage of push surface 55 is that it provides a surface which a user can grab, push, pull, or generally manipulate so as to aid in moving measuring scoop 10.

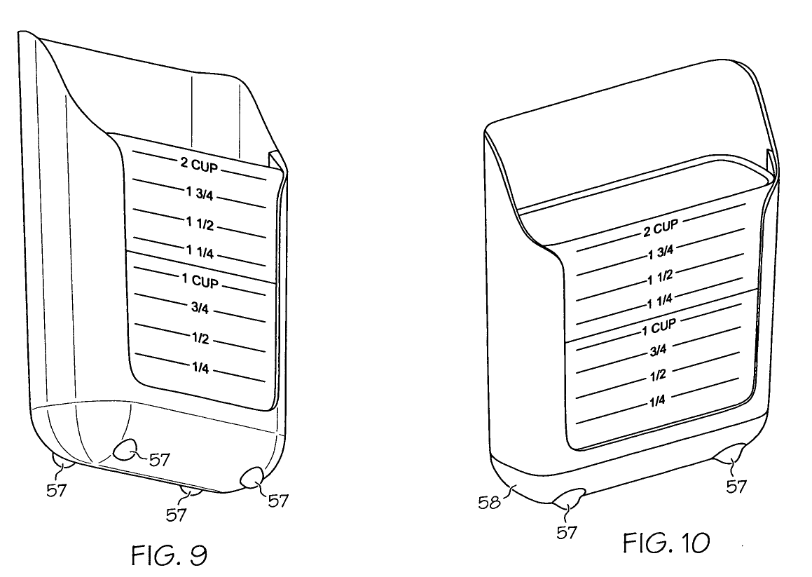

As shown in FIGS. 5 and 7, scoop shell 11 may also include structures that allow it to stand in a generally upright position. Such structures may include bottom support ridges 56. Ridges 56 may run in any direction, and include any number. However, in the preferred illustrated embodiment, a pair of spaced ridges 56 is generally aligned such that scoop shell can stand in a generally vertical position. A further embodiment is shown in FIG. 9 in which scoop shell includes legs 57. Legs 57 can be bump-like structures, preferably of a soft or rubberized material such as silicone rubber. Again, legs 57 can be present in a variety of numbers and locations, but preferably legs 57 are positioned proximate bottom 26 of scoop shell 11 and are positioned so as to allow measuring scoop 10 to stand in a generally vertical position. It is desired that measuring scoop be allowed to rest or stand in a generally upright, vertical position so as to better allow food material to settle within measuring insert 12.

Referring next to FIG. 10 there is shown a further embodiment of measuring scoop 10. In this figure, measuring scoop 10 includes the feature of legs 57 as well as a rubber grip bottom area 58. The rubber grip bottom area 58 is an area proximate the bottom 26 of scoop shell 11 and generally on the outer portion of scoop shell 11, or that area of measuring scoop 10 that a user would grab or push. A thin later of rubber material, such as a silicone rubber can cover this area 58. The surface of the rubber grip bottom area 58 thus provides a friction surface which a user can easily grab and manipulate.

Optionally scoop shell 11 may include friction surfaces, not shown, such as bumps or ridges positioned on the outer surfaces of first side 22 and/or second side 24. The friction surfaces provide a structure with which a user's fingers and hand can make good contact so as to more easily manipulate the measuring scoop.

Measuring scoop 10 and its components are intended for food use. Therefore these items are preferably manufactured of food safe materials such as, but not limited to, plastics, especially food grade plastics, metal alloys including stainless steel, ABS, nylons, and the like. In a preferred embodiment the items are manufactured by an injection molding process or similar process. The components are preferably reusable, washable, and dishwasher safe.

Having described the invention from a structural standpoint, a preferred method of using measuring scoop 10 will now be described. The following discussion can also be referenced with respect to FIG. 8. It is assumed that the chef/user has prepared a portion of food materials, such as a pile of chopped carrots (step 80), and the chef now desires to measure and transfer this food material. Preferably the food materials are placed on a relatively flat and stable surface such as a cutting board, plate, or kitchen counter. The measuring scoop 10 is assembled (step 81); i.e., at least first measuring insert 31 is positioned within scoop shell 11. It is particularly noted that the assembly of measuring scoop 10 can take place prior to any food preparation work (step 81); and indeed it is anticipated that a user may leave measuring scoop 10 in its assembled position in a kitchen drawer or other storage area. Preferably first insert 31 is positioned in the fully bottomed position such that holding structure 38 (dent or other setting means) reciprocally engages the structure 38 positioned on shell 11. If desired the chef can also deploy second measuring insert 35 within shell 11; and if the chef uses second measuring insert 35 it is preferred that insert 35 be placed in its fully bottomed position such that second insert 35 engages with first measuring insert 31. The user can now deploy measuring scoop 10 so as to scoop up the food materials. In doing so, the chef preferably positions measuring scoop 10 such that at least a portion of scooping edge 27 contacts the cutting surface and preferably, scooping edge 27 makes substantially flat contact with the cutting edge. The chef can now push or manipulate the measuring scoop 10 such that the food material passes over the scooping edge 27 and onto pan area or back 21 of shell 11. This scooping motion (step 82) alone may serve to transfer food materials into the measuring inserts 31 and 35. Alternatively, by lifting scoop edge 27 off the cutting surface and carefully bringing the measuring scoop 10 into a generally vertically position (so as to avoid substantially spilling food material from the pan area), the force of gravity can be used to draw the food materials down into measuring inserts. Continuing with step 83, measuring scoop 10 is raised to a generally vertical position, and food material is allowed to settle in measuring insert 12. At this point the chef/user can measure the quantity of food material held in insert 12 (step 84). As noted this is typically a visual operation of marking the top level of the food against a line on indicia 39. Step 85 notes that the previous steps, particularly steps 82-84, can be repeated until a desired quantity of food material has been collected. Alternatively, if too much material has been collected, the user can dump out a portion of the contents (step 86). In this manner the quantity of food is adjusted until a desired amount is held in the measuring scoop 10. Now the user can transfer the contents to a desired cooking location, such as a stew pot, and dump the measured food material into that location (step 87). If desired, the user can remove measuring insert 12, and then dump the food material into a desired pan, pot, or vessel, and then replace the insert. Alternatively, the entire assembled measuring scoop 10 can be taken to the vessel and its contents emptied therein.

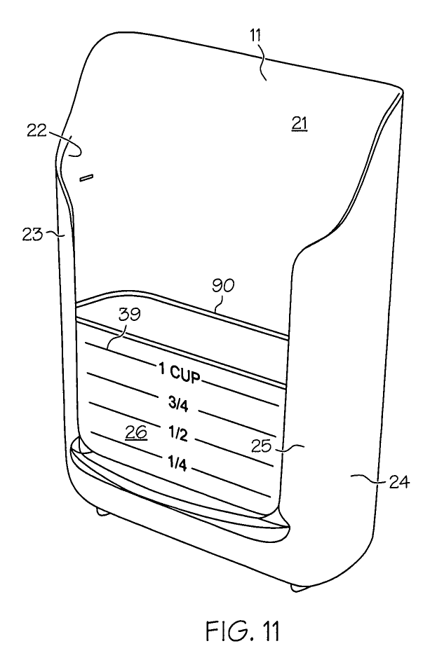

An additional embodiment of measuring scoop 10 is now described with reference to FIG. 11. An alternative embodiment includes a scoop shell 11. The scoop shell 11 includes a back 21, two sides 22 and 24, and bottom 26. The alternative embodiment of the scoop shell 11 may or may not include the first and second wing feature (23 and 25) as earlier described. However, instead of a measuring insert, the alternative measuring scoop includes a face piece 90 that spans across the opening between the first and second sides (22 and 24) of scoop shell 11; face piece 90 may be substantially clear. If wing structures (23 and 25) are present, face piece 90 may attach to the wing structures (23 and 25). The face piece 90 may be permanently attached or may be removable. In a preferred embodiment, face piece 90 is a substantially planar, sheet-like structure that helps to define an enclosure. The face piece 90 may have measuring indicia 39 thereon similar to the indicia 39 described for measuring insert 12. Face piece 90 together with scoop shell 11, define a food space such that food scooped onto scoop shell, falls into the food space. Upon standing measuring scoop in an upright position, the food can then be measured against the indicia included on face piece.

In various locations, the measuring scoop has been described as comprising a transparent material, a clear material, or a see-through material. It should be appreciated that the degree of transparency, clarity, or the degree to which an observer can see through the material, is just such a degree as would allow a user of the device to generally observe the level or top of the food material held within the scoop so that the user can meaningfully measure the amount of material against a measuring mark. Thus, the embodiments of the scoop can be used with many varying degrees of transparency or clarity.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

What is claimed is:

1. A measuring scoop for use in handling and measuring food materials comprising:
a scoop shell; and
a measuring insert positioned in the scoop shell.

2. The measuring scoop according to claim 1 wherein the measuring insert comprises a lower measuring insert and an upper measuring insert.

3. The measuring scoop according to claim 2 wherein the lower measuring insert and the upper measuring insert further comprise a means for reciprocally connecting.

4. The measuring scoop according to claim 1 wherein the scoop shell and the measuring insert comprise means for reciprocally attaching.

5. The measuring scoop according to claim 1 wherein the measuring insert includes measuring indicia.

6. The measuring scoop according to claim 5 wherein the measuring indicia includes a quantity designation of one cup.

7. The measuring scoop according to claim 1 wherein the scoop shell further comprises a grip positioned proximate to a bottom of the shell.

8. The measuring scoop according to claim 1 wherein the scoop shell further comprises bottom support ridges on which the scoop can rest in a generally vertical position.

9. The measuring scoop according to claim 1 wherein the scoop shell further comprises a push surface.

10. The measuring scoop according to claim 1 wherein the scoop shell further comprises legs.

11. The measuring scoop according to claim 1 wherein the scoop shell further comprises a rubber grip bottom area.

12. The measuring scoop according to claim 1 wherein the scoop shell and measuring insert comprise a metal alloy.

13. The measuring scoop according to claim 1 wherein the measuring insert comprises a substantially transparent matrix.

14. The measuring scoop according to claim 11 wherein the measuring insert is held in the scoop shell such that the scoop shell allows a user to view food materials held in-the measuring insert.

15. A measuring scoop for scooping and measuring chopped food material comprising:
a scoop shell having a back with a leading edge, a first side with a first wing, a second side with a second wing, and a bottom, and the scoop shell defining a holding area;
a lower measuring container, the container having indicia for measuring the amount of chopped food held within the container;
an upper measuring container such that the second measuring container links with the lower measuring container; and
wherein the scoop shell, the lower measuring container, and the upper measuring container are configured such that the lower measuring container and the upper measuring container are positioned within the holding area of the scoop shell.

16. The measuring scoop according to claim 15 wherein the first measuring container includes indicia for measuring up to approximately 1 cup of food material, and the second measuring container includes indicia for measuring up to approximately 2 cups of food material.

17. The measuring scoop according to claim 15 wherein the first measuring container and the second measuring container comprise a substantially clear plastic matrix.

18. The measuring scoop according to claim 15 wherein the lower measuring container comprises a bottom, a front, a back, a first side, and a second side, and wherein the front, back, first side, and second side define a top edge; and wherein the upper measuring container comprises a front, a back, a first side, and a second side, and wherein the front, back, first side, and second side define a bottom edge; and wherein the top edge of the lower measuring container links with the bottom edge of the upper measuring container.

19. The measuring scoop according to claim 15 wherein the lower measuring container is linked with the upper measuring container through a joint selected from the group consisting of: butt joint, lap joint, rabbet joint, tongue-and-groove joint, dado joint, scarf joint, and splice joint.

20. The measuring scoop according to claim 15 wherein the scoop shell, the lower measuring container, and the upper measuring container each comprise a holding structure such that the lower measuring container and the upper measuring container can be attached to the scoop shell.

21. The measuring scoop according to claim 15 wherein the leading edge of the scoop shell is adapted for scooping food materials.

22. A method for scooping and measuring food material with a single food implement, the method comprising the steps of:
sliding a measuring scoop having a front edge along a surface where the food material is disposed so as to scoop food material onto the measuring scoop;
raising the measuring scoop from the surface to a substantially so as to allow the food material to settle into a substantially clear measuring insert with measuring indicia positioned on the measuring insert; and
viewing the level of the food material against the measuring indicia so as to determine the quantity of food material.

23. The method according to claim 22 further comprising the step of positioning a first measuring insert within a scoop shell so as to assemble the measuring scoop for measuring up to 1 cup of food material.

24. The method according to claim 23 further comprising the step of positioning g a second measuring insert within a scoop shell so as to assemble the measuring scoop for measuring up to 2 cups of food material.

25. A measuring scoop comprising:
a scoop shell having a back, a first side, a second side, and a bottom so as to define an opening; and
a face piece connected to the scoop shell so as to cover the opening.

26. The measuring scoop according to claim 25 further comprising a first wing structure affixed to the first side and a second wing structure affixed to the second side, and wherein the face piece is connected to the first wing structure and the second wing structure.
